(19) United States
(12) Patent Application Publication
(10) Pub. No.: US 2003/0045147 A1
(43) Pub. Date: Mar. 6, 2003

(54) Safe connecting end structure for multi-wire and multi-loop flexible lamp pipe

(75) Inventor: Peter K. H. Huang, Taipei (TW)

Correspondence Address: DOUGHERTY & TROXELL, SUITE 1404, 5205 LEESBURG PIKE, FALLS CHURCH, VA, 22041, US

(73) Assignee: Shining Blick Enterprises Co., Ltd.

(21) Appl. No.: 09/940,586

(22) Filed: Aug. 29, 2001

(51) Int. Cl. H01R 24/00

(52) U.S. Cl. 439/226

(57) ABSTRACT

A safe connecting end structure for a multi-wire and multi-loop flexible lamp pipe, wherein a transparent flexible pipe of the lamp pipe is provided therein with a plurality of lamp strings and related conductors, the two ends of the pipe are provided with a male insertion end and a female insertion end respectively, the ends of the conductors are provided with male and female metallic conducting members respectively connectable by insertion to each other; high temperature durable inner sleeves are formed at the junctions of the ends of the conductors and the metallic conducting members, and male and female external sleeves are formed about the inner sleeves at the male and female insertion ends.

### BACKGROUND OF THE INVENTION

1. Field of the Invention

The present invention is related to a safe connecting end structure for a multi-wire and multi-loop flexible lamp pipe, and especially to such a connecting end capable of effectively increasing safety of use of such a flexible lamp pipe.

2. Description of the Prior Art

Conventional decorative lamps mostly are illuminating or flashing lamp strings formed from a lot of lamp bulbs connecting in series on conductors. Generally, a flexible lamp pipe have a plurality of lamp strings mounted in a flexible transparent pipe, so that the entire decorative lamp can be bent into various patterns, letters or the like, in this way, usage of such a flexible lamp pipe is more variant.

Using of a transparent flexible lamp pipe was disclosed in an earlier U.S. Pat. No. 3,755,663, and a flexible lamp pipe was disclosed in a U.S. Pat. No. 4,812,956 on which the strip like lamp pipe can be cut at a desired length. However, no matter which kind of structure the flexible lamp pipe is, basically, it must be provided in the pipe with multiple conductors and lamp strings. For example, the embodiment disclosed in U.S. Pat. No. 4,812,956 includes two lamp strings in the pipe (two loops) which use three conductors; or includes four lamp strings in the pipe which use five conductors. The above stated flexible lamp pipe with three conductors and two lamp strings has the ends of the two lamp strings connected to two conductors respectively, and has the other ends connected to a common conductor, it can be cut at a specific position.

However, no matter such flexible lamp pipe is of a structure able to be cut or of a specific length, when it is bent to form a desired pattern or a letter, each section of lamp pipe obtained shall be connected with another section. However, by the nature of such flexible lamp pipe, after cutting or when being given with a specific length and when it is used outdoors, in some countries with severer regulation about safety, it often is hard to pass an examination of safety.

And more, such a multi-wire and multi-loop flexible lamp pipe must be arranged to have multiple concentric conductors within a limited pipe diameter, the most external conductors thereamong of them are very close to the external periphery of the transparent flexible lamp pipe to render the structure formed very unsafe.

### SUMMARY OF THE INVENTION

The object of the present invention is to provide a safe connecting end structure for a flexible lamp pipe in which high temperature durable inner sleeves are formed at the junctions of the ends of conductors and metallic conducting members, and external sleeves are formed by ejection molding about the inner sleeves. In a preferred embodiment, the inner sleeves can be made of mixed material of nylon and fiber glass, in order that end connecting of the flexible lamp pipe can be safe to meet more severe regulations.

In a practicable embodiment, multiple extension sections of conductors in the above stated flexible lamp pipe can be bent in advance to get away from the external periphery of the lamp pipe, then are fixed in position by the abovementioned forming of high temperature durable inner sleeve.

The present invention will be apparent in its novelty and features after reading the detailed description of the preferred embodiment thereof in reference to the accompanying drawings.

### BRIEF DESCRIPTION OF THE DRAWINGS

FIG. 1 is a perspective view showing application of a preferred embodiment of the present invention with two flexible lamp pipes connected at their mutually confronting ends;

FIG. 2 is a sectional view of the two flexible lamp pipes in FIG. 1;

FIG. 3 is a perspective view showing adding of a fast connector in the preferred embodiment of FIG. 1;

FIG. 4 is a sectional view showing assembling of the preferred embodiment of FIG. 3;

FIG. 5 is a perspective view showing connecting of a flexible lamp pipe with an end cap of the present invention;

FIG. 6 is an anatomic perspective view showing the elements in FIG. 5;

FIG. 7 is an anatomic perspective view further showing the cap in FIG. 6;

FIG. 8 is a schematic view showing an externally extending section of a conductor of the present invention used in a preferred embodiment with three conductors and two loops before forming of its pipe end;

FIG. 9 is an end view of the preferred embodiment in FIG. 8;

FIG. 10 is a perspective view showing that the preferred embodiment in FIG. 8 is added with a high temperature durable inner sleeve;

FIG. 11 is a perspective view continuingly showing that the preferred embodiment in FIG. 8 is added with an external sleeve;

FIG. 12 is a schematic view showing an externally extending section of a conductor of the present invention used in a preferred embodiment with five conductors and four loops before forming of its pipe end;

FIG. 13 is an end view of the preferred embodiment in FIG. 12;

FIG. 14 is a perspective view showing the preferred embodiment in FIG. 12 is added with a high temperature durable inner sleeve;

FIG. 15 is a perspective view continuingly showing that the preferred embodiment in FIG. 14 is added with an external sleeve.

### DETAILED DESCRIPTION OF THE PREFERRED EMBODIMENT

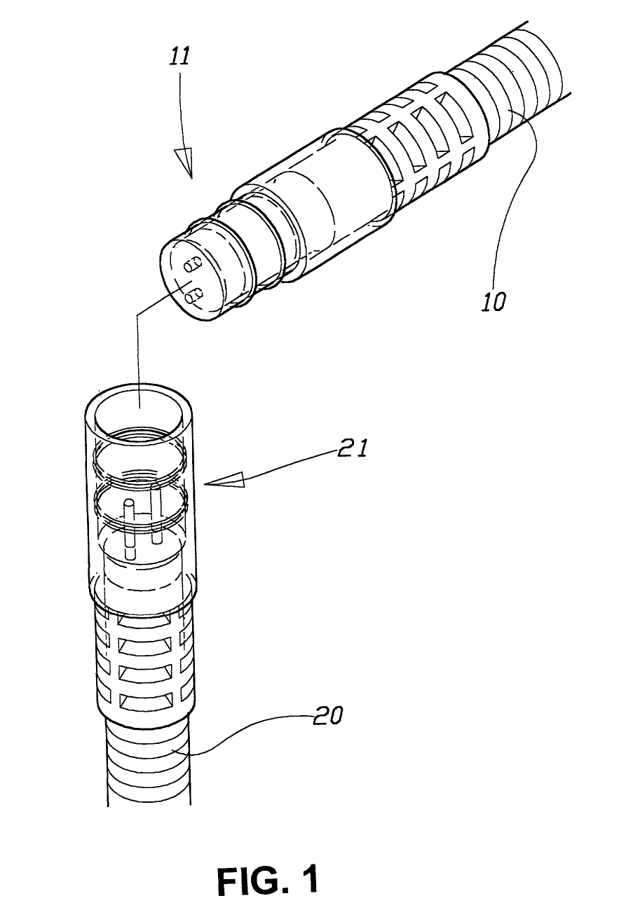

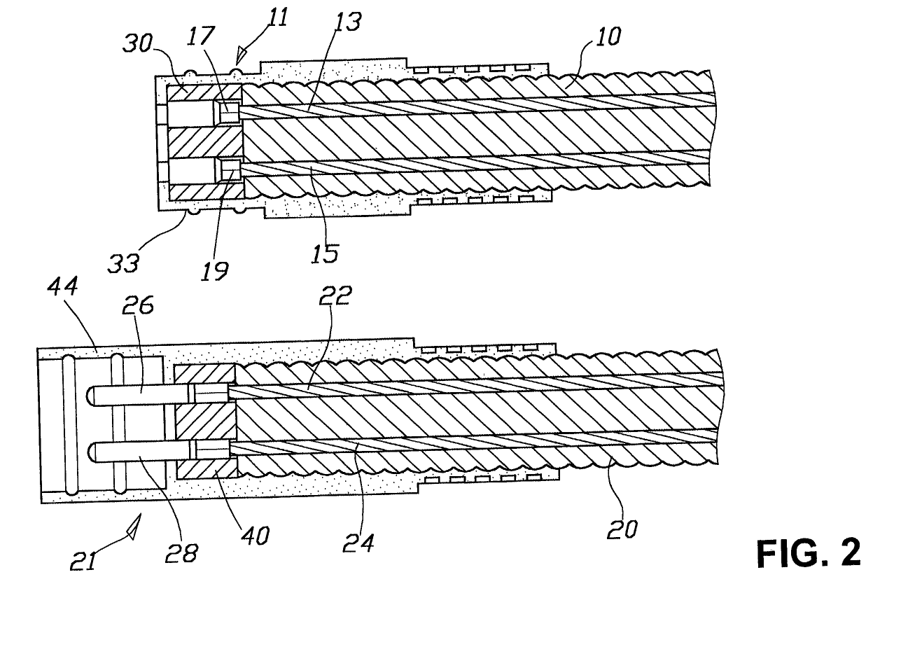

Referring to FIGS. 1 and 2, in this example to connect two flexible lamp pipes 10, 20 (both are made of transparent and flexible insulating material) at their mutually confronting ends, the lamp pipe 10 therein is provided with a female insertion end 11, while the opposite lamp pipe 20 is provided with a male insertion end 21 connectable with the female insertion end 11. In the female insertion end 11 of the lamp pipe 10, two conductors 13, 15 have their ends connected with two female metallic conducting members 17, 19. While in the male insertion end 21 of the opposite lamp pipe 20, two conductors 22, 24 have their ends connected with two male metallic conducting members 26, 28.

The present invention is characterized by that, inner sleeves 30, 40 can be formed respectively at the connecting areas of the conductors 13, 15 and 22, 24 of the lamp pipes 10, 20 with the metallic conducting members 17, 19 and 26, 28, and male and female external sleeves 33, 44 are formed thereabout to allow the ends of the lamp pipes 10, 20 to mutually insertion connect with each other.

In the preferred embodiment, the abovementioned inner sleeves 30, 40 are made of high temperature durable material such as mixed material of nylon and fiber glass, the material is quite ideal low cost material.

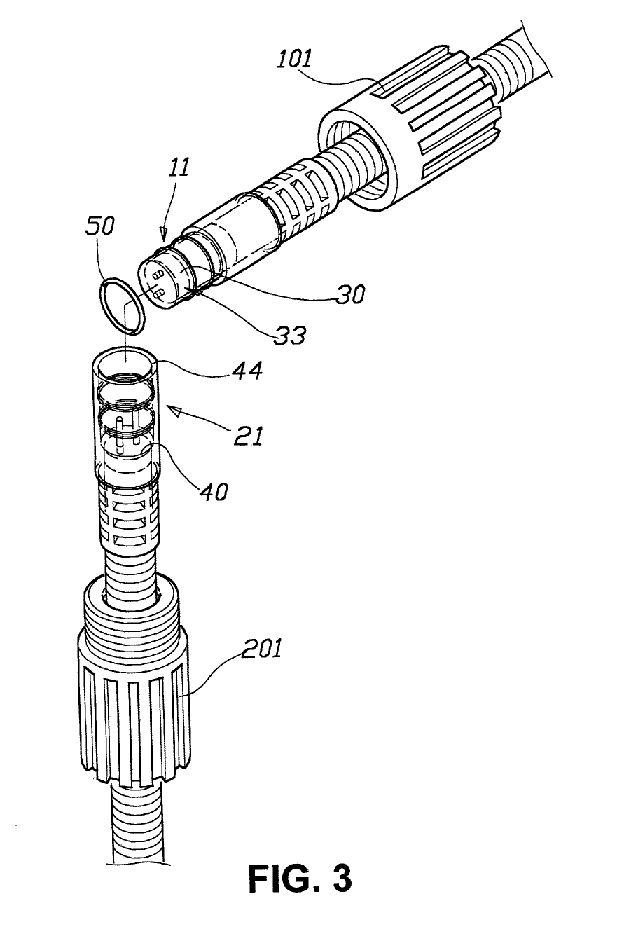

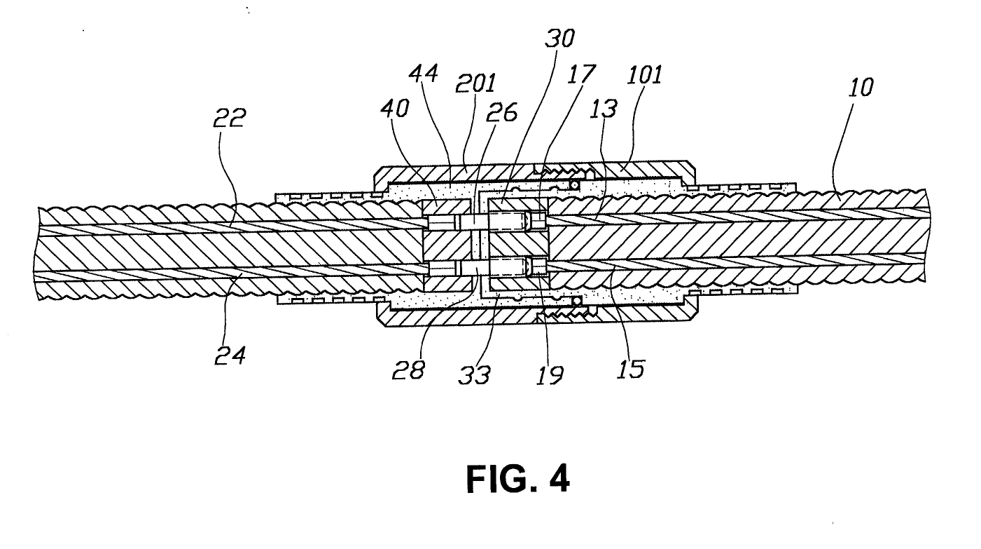

As shown in FIGS. 3, 4, the present invention having the abovementioned lamp pipes 10, 20 insertion connected has a leakage-proof gasket 50 therebetween, the female metallic conducting members 17, 19 and the male metallic conducting members 26, 28 on the ends of the mutually confronting ends of the lamp pipes 10, 20 are connected mutually, and the male insertion end 21 connects with and enters the female insertion end 11, two connectors 101, 210 of the lamp pipes 10, 20 respectively can be fast connected into one.

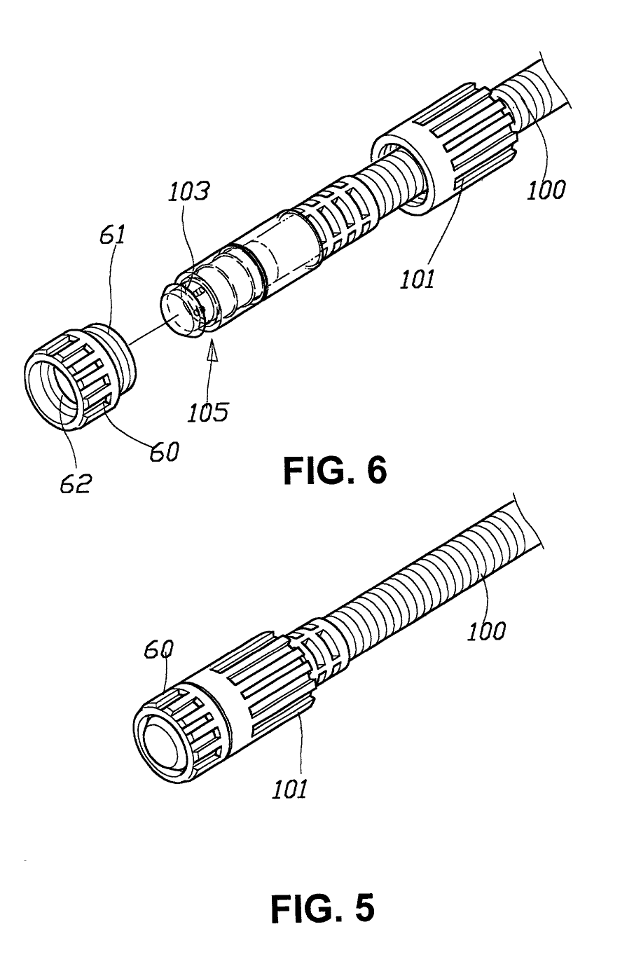

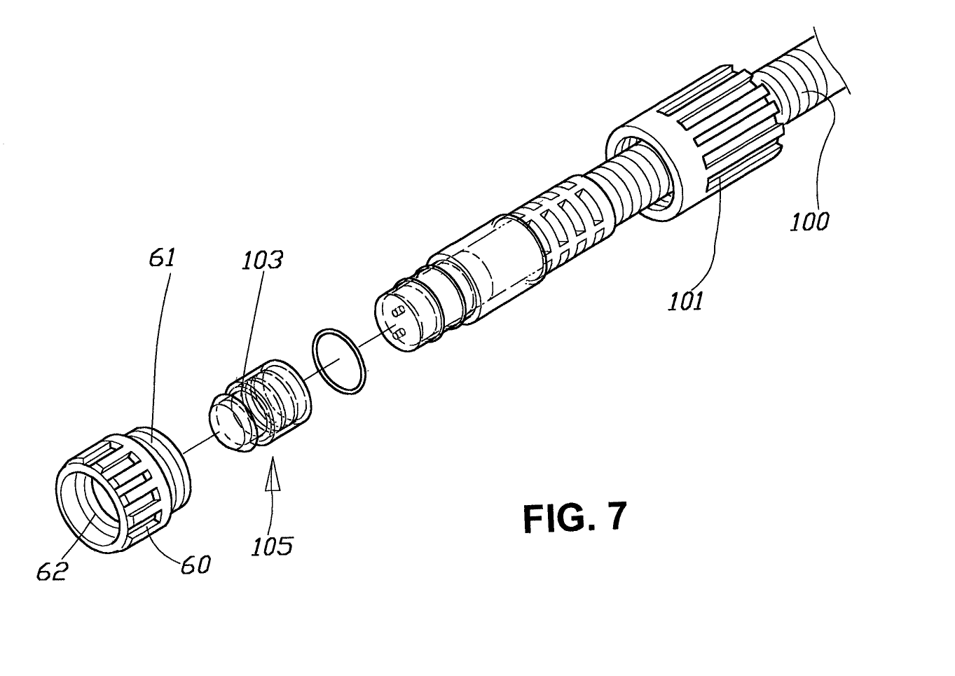

As shown in FIGS. 5-7, an improved flexible lamp pipe 100 of the present invention can also be connected with an end cap 60 by providing an insertion connecting end 105 having a recessed neck 103 on the end of the lamp pipe 10. The end cap 60 has a threaded portion 61 of which the thread matches with the inner thread of the connector 101 and has an inner annular protruding piece 62 near the end thereof, for the purpose that it can be insertion connected with the insertion connecting end 105.

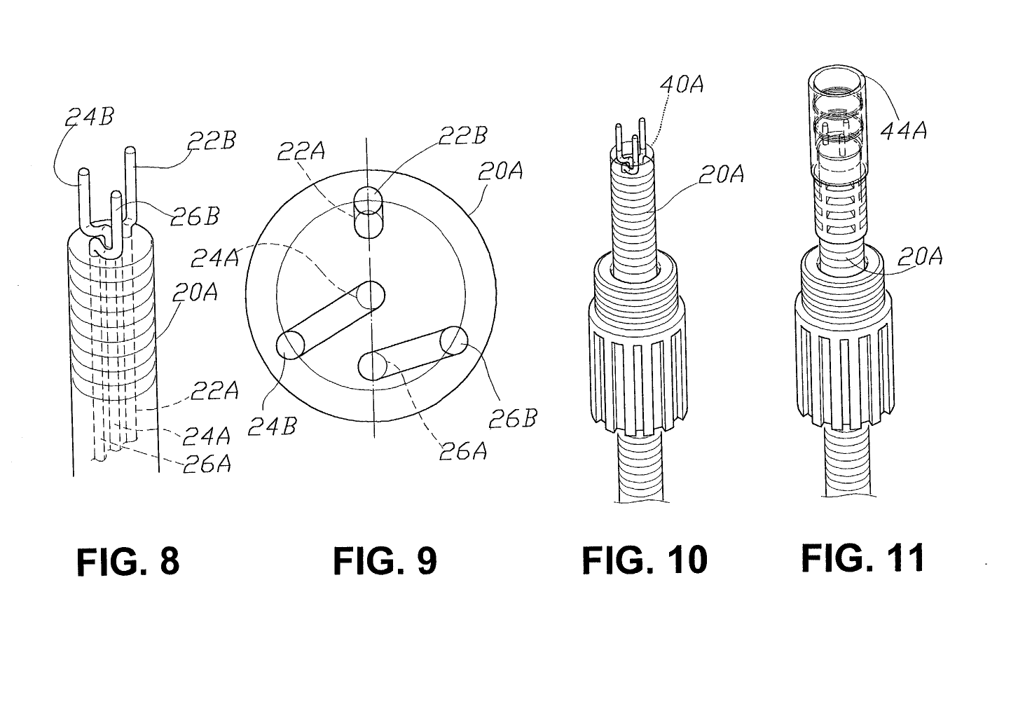

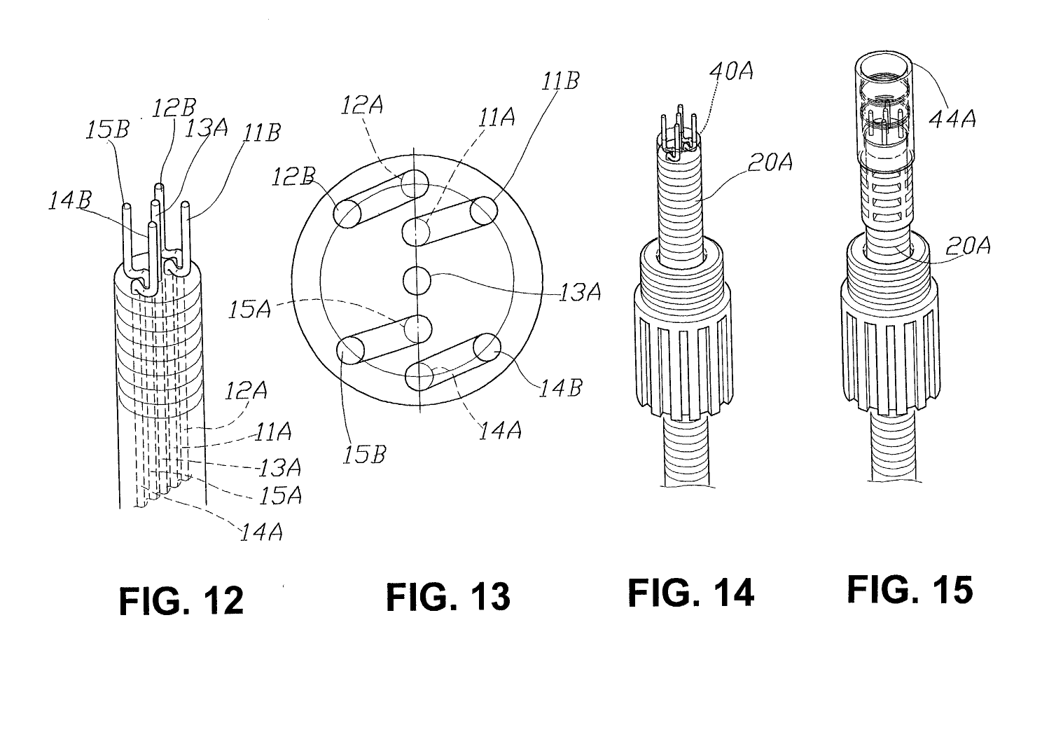

FIGS. 8 and 9 show that the present invention uses a lamp pipe 20A with three conductors and two loops, wherein, there are 5 three conductors 22A, 24A and 26A arranged in a diametrical line (as shown by the dotted line in the drawings), the prepared exposing sections of the conductors 22A, 24A and 26A and the metallic conducting members having been connected are bent away from the periphery of the lamp pipe 20A before the prepared exposing sections are connected with the metallic conducting members and as shown in FIGS. 10 and 11 are formed respectively an inner sleeve 40A and external sleeve 44A. In the preferred embodiment shown, the prepared exposing sections of the three conductors 22A, 24A and 26A can be bent to an extent to form an equilateral triangle 22B, 24B, 26B (as shown in FIG. 9). Similarly, as shown in FIGS. 12-15, when the present invention uses a lamp pipe with five conductors 11A, 12A, 13A, 14A and 15A, and when an inner sleeve is formed, the conductors 11A, 12A, 13A, 14A and 15A are bent to form an equilateral quadrangle 11B, 12B, 13B, 14B and 15B, and then an external sleeve is formed (as shown in FIG. 15). The advantage of the above stated embodiment is that, the most external conductors originally arranged in a diametrical line can be kept away from the periphery of the lamp pipe, and the distance between every two of the intermediate conductors is enlarged, thereby, safety of the lamp pipe can be increased.

With such an improved structure of the present invention, when such a flexible lamp pipe is used outdoors to be electrically connected for a long time, by the high temperature durable improved structure of the connecting portion, the flexible lamp pipe can be safe to meet more severe regulations.

The embodiments cited above are only for illustrating a preferred embodiment of the present invention. It will be apparent to those skilled in this art that various modifications or changes can be made to the elements of the present invention without departing from the spirit and scope of this invention. Accordingly, all such modifications and changes also fall within the scope of the appended claims and are intended to form part of this invention.

1. A safe connecting end structure for a multi-wire and multi-loop flexible lamp pipe, wherein a transparent flexible pipe of said lamp pipe is provided therein with a plurality of lamp strings and related conductors, the two ends of said pipe are provided with a male insertion end and a female insertion end respectively, the ends of said conductors are provided with male and female metallic conducting members respectively connectable by insertion to each other; high temperature durable inner sleeves are formed at the junctions of said ends of said conductors and said metallic conducting members, and male and female external sleeves are formed about said inner sleeves at said male and female insertion ends.

2. A safe connecting end structure for a multi-wire and multi-loop flexible lamp pipe as claimed in claim 1, wherein said inner sleeves are made of mixed material of nylon and fiber glass.

3. A safe connecting end structure for a multi-wire and multi-loop flexible lamp pipe, wherein, said lamp pipe has a plurality of lamp strings and related conductors mounted in a flexible transparent pipe thereof, prepared exposing sections of said conductors are provided for mounting metallic conducting members and forming a male insertion end as well as a female insertion end, said conductors and metallic conducting members are bent to form a polygonal arrangement, high temperature durable inner sleeves are formed at the junctions of the ends of said conductors and metallic conducting members, and male and female external sleeves are formed about said inner sleeves.

4. A safe connecting end structure for a multi-wire and multi-loop flexible lamp pipe as claimed in claim 3, wherein
said lamp pipe has three conductors and two lamp strings, said arrangement of said exposing sections of said conductors and metallic conducting members is in the shape of an equilateral triangle.

5. A safe connecting end structure for a multi-wire and multi-loop flexible lamp pipe as claimed in claim 3, wherein
said lamp pipe has five conductors and four lamp strings, said arrangement of said exposing sections of said conductors and metallic conducting members is in the shape of an equilateral quadrangle.
